(19) United States
(12) Patent Application Publication
(10) Pub. No.: US 2008/0059961 A1
(43) Pub. Date: Mar. 6, 2008

(54) Output of Help Elements that Correspond to Selectable Portions of Content

(75) Inventors: Emmanuel Jose Miranda-Steiner, Redmond, WA (US); Michael C. Kunz, Seattle, WA (US); Suji Lakshminarayanan, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/469,393

(22) Filed: Aug. 31, 2006

(51) Int. Cl. G06F 9/44

(52) U.S. Cl. 717/171

(57) ABSTRACT

Techniques are described to output help elements that correspond to selectable portions of content. Content, for instance, may be output in a user interface having a plurality of selectable portions and a help element. The user interface may be updated in response to sequential selection of the plurality of selectable portions by retrieving corresponding help elements stored locally on the client and outputting the corresponding help elements as synchronized with the sequential selection.

### BACKGROUND

Users are exposed to an ever increasing variety of content over a network, such as web pages and so on. Oftentimes, the users interact with this content to provide information, such as to logon to a website, purchase goods and services, input directions to receive a map, specify how to download content, and so on. During this interaction, the users may have questions regarding what is desired in various fields used to receive the content, such as particulars of the information to be entered. For example, the content may request that the user enter an address but not specify a format for the address, which address should be supplied (e.g., business, billing, home), and so forth.

Previous techniques which were used to assist the users, however, were cumbersome and often cluttered a user interface when outputting the “help” information. Therefore, the users may become frustrated during the entry process and even choose to forgo interaction with the content, which may thereby result in missed business opportunities on the part of a retailer, limit traffic to desired destinations provided by a service provider, and so on.

### SUMMARY

Techniques are described to output help elements that correspond to selectable portions of content. In an implementation, content is output in a user interface having a plurality of selectable portions and a help element. The user interface is updated in response to sequential selection of the plurality of selectable portions by retrieving corresponding help elements stored locally on the client and outputting the corresponding help elements as synchronized with the sequential selection.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques to output help elements that correspond to selectable portions of content.

FIGS. 2 and 3 are illustrations of exemplary user interfaces in an implementation showing sequential output of help elements in response to sequential selection of selectable portions in the respective user interfaces.

FIG. 4 is an illustration of a user interface in which help elements that correspond to selectable portions are aggregated for display in the user interface.

FIG. 5 is an illustration of a user interface in which help elements that correspond to selectable portions are aggregated for display in the user interface in a separate window.

FIG. 6 is a flow diagram depicting a procedure in an exemplary implementation in which help elements are retrieved from local storage that correspond to selectable portions included in content obtained over a network.

FIG. 7 is a flow diagram depicting a procedure in an exemplary implementation in which focus is applied to groups of selectable portions in a user interface, the groups further defining which help elements are output in the user interface.

FIG. 8 is a flow diagram depicting a procedure in an exemplary implementation in which a control is used to switch between modes to manage output of help elements.

### DETAILED DESCRIPTION

Overview

Users have access to ever increasing varieties of content. In some instances, interaction with this content is used to provide information. For example, a user may interact with content to input a user name, password and billing information to form an account to purchase goods and services. During the entry of this information, however, the user may have questions regarding the entry process, such as why particular information is needed (e.g., identification of letters in a picture), where to locate the information (e.g., a code on the back of a credit card), and so forth. Previous techniques which were used to provide this information, however, may involve manual initiation on the part of the user of a feature to output help information, may result in “cluttering” of a user interface that outputs the content and the information, and so on.

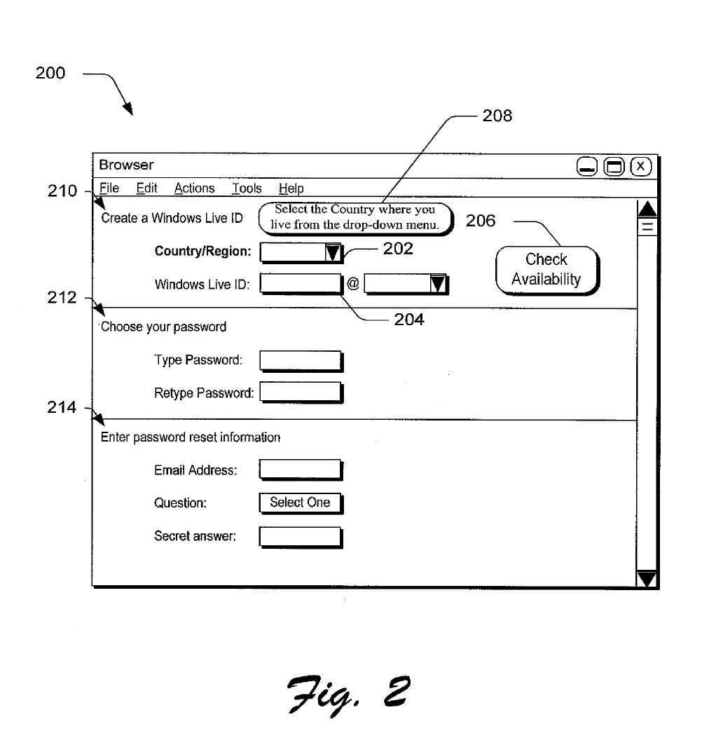

Accordingly, techniques are described in which help elements are output that correspond to selectable portions of content. For example, a user may receive a web page from a service provider having a variety of portions that are selectable by the user to enter information. As the user sequentially navigates through the selectable portions, help elements may also be sequentially displayed in the user interface, thereby reducing the amount of “clutter” in the user interface. In an implementation, the help elements are retrieved locally from the client after identification of the particular selectable portion, e.g., a title field, name field, and so on. Thus, the elements are provided from “outside” of the content and may thus be used with content that was not specifically configured to provide the elements. Further discussion of sequential navigation through selectable portions may be found in relation to FIGS. 2-3 and 6.

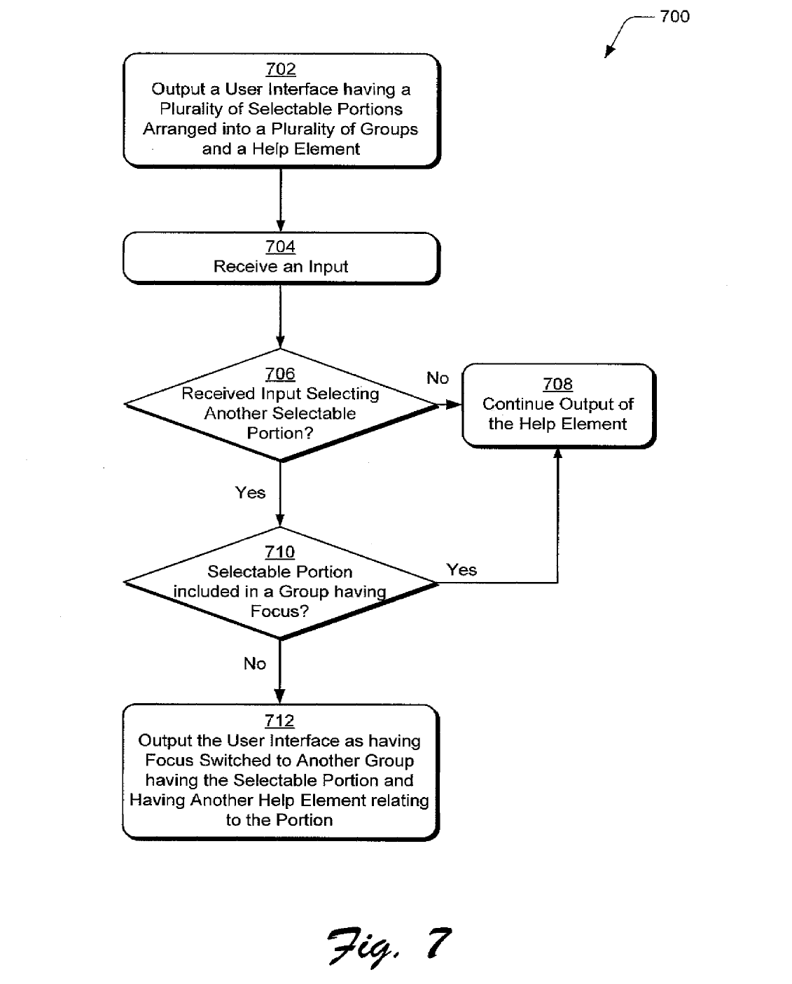

In another implementation, the selectable elements may be placed in groups, such as related by topic and so on. Help elements may then be provided based on these groupings, such as to provide a “default” help element when a help element that matches the particular selectable portion cannot be found. The client, for instance, may identify a particular selectable portion as relating to a particular topic but does not have a specific help element that matches the portion. Therefore, a default help element that relates to that topic may be output to assist the user, further discussion of which may be found in relation to FIG. 7.

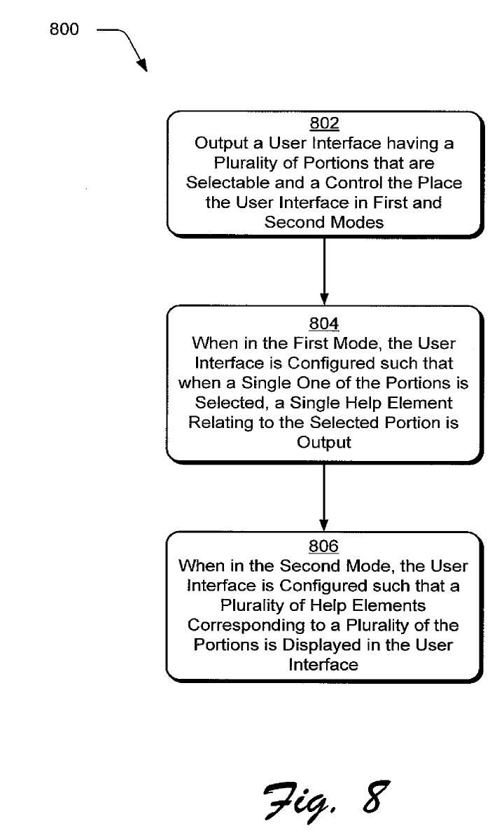

In a further implementation, a control is provided to place the user interface in different modes to control output of the help elements. In a first mode, when a single portion is selected, a single help element relating to the selected portion is output and when in a second mode, a plurality of help elements corresponding to a plurality of portions is displayed in the user interface. For example, the control may be used to enable sequential display of the help elements during sequential selection of the elements such that a single element is displayed at any one time in the first mode. When in the second mode, each help element that corresponding to a portion displayed in the user interface is output concurrently. Further discussion of the use of the control and modes may be found in relation to FIG. 8.

In the following discussion, an exemplary environment and user interfaces are first described that are operable to perform techniques to output help elements that correspond to selectable portions of content. Exemplary procedures are then described that may be employed in the exemplary environment, as well as in other environments.

Exemplary Environment and User Interfaces

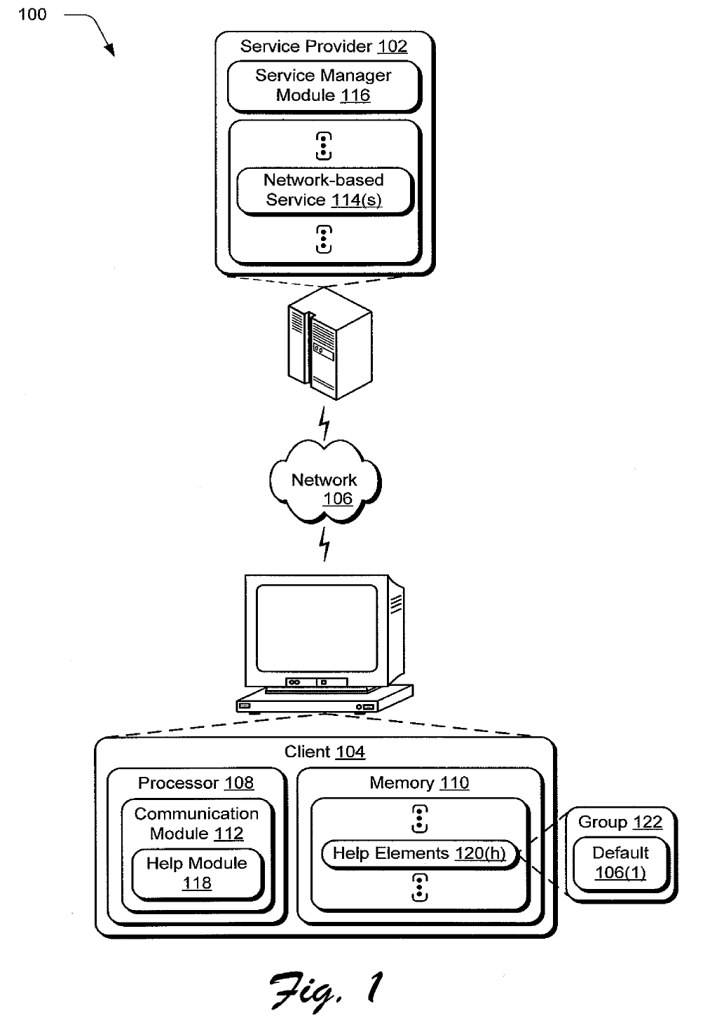

FIG. 1 is an illustration of an environment 100 in an exemplary implementation that is operable to employ techniques to output help elements that correspond to selectable portions of content. The illustrated environment 100 includes one or more content providers 102 and one or more clients 104 that are communicatively coupled, one to another, via a network 106. In the following discussion, the service provider 102 and the client 104 may be representative of one or more entities, and therefore reference may be made to a single entity (e.g., the client 104) or multiple entities (e.g., the clients 104, the plurality of clients 104, and so on).

The client 104 may be configured in a variety of ways for network 106 access. For example, the client 104 may be configured as a computing device as illustrated, such as a desktop computer, a mobile station, an entertainment appliance, a set-top box communicatively coupled to a display device, a wireless phone, a game console, and so forth. The client 104, in portions of the following discussion, may also relate to a person and/or entity that operate the clients. In other words, one or more of the clients 104 may describe logical clients that include users, software, and/or devices.

The service provider 102 is illustrated in FIG. 1 as being implemented by a server and the client 104 is illustrated as a client device. Accordingly, the client 104 is illustrated as having a processor 108 and memory 110. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 10 is shown for the client 104, a wide variety of types and combinations of memory may be employed, such as random access memory (RAM), hard disk memory, removable medium memory, and other types of computer-readable media.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The client 104 is illustrated as executing a communication module 112 on the processor 108, which is also storable in memory 110. The communication module 112 is representative of an executable module that is configured to communicate with the service provider 102 over the network 106. For example, the communication module 112 may be configured as a web browser that allows the client 104 to “surf” the Internet. In another example, the communication module 112 is configured as a “smart” module that is configured to provide other network functionality as a part of its operation, such as an instant messaging module, an email module, an online banking module, and so on. A wide variety of other examples are also contemplated.

The communication module 112, for instance, when executed on the processor 108 may interact with one or more network-based services 114(s) that are managed by the service provider 102 through execution of a service manager module 116. The network-based services 114(s) may be configured in a variety of ways, such as to provide email, instant messaging, web pages, online banking, web logs (i.e., blogs), and so on. As previously described, one or more of the network-based services 114(s) may be configured to accept information input by a user, such as to “logon” to the network-based service 114(s).

To assist the user in inputting the information and otherwise interacting with the network-based service 114(s), the communication module 112 is illustrated as including a help module 118. The help module is representative of functionality to locate one or more help elements 120(h) which correspond to selectable portions of the content, such as a field to enter text, select from a drop-down menu, and so on. Thus, in this example, the help module 118 retrieves help elements 120(h) stored locally on the client 104 that correspond to selectable portions of content (e.g., a web page) received via a network-based service 114(s) over the network.

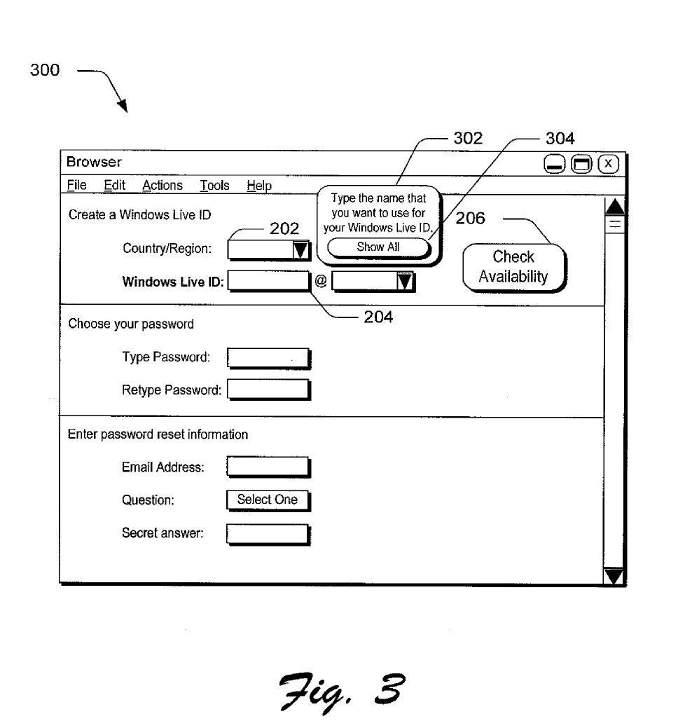

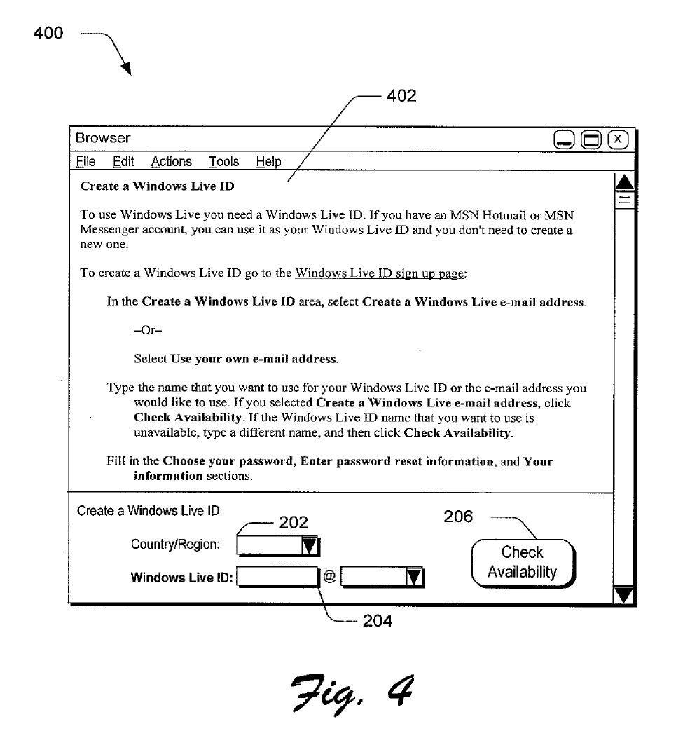

The help elements may be arranged for output in a variety of ways. For example, output of the help elements 120(b) may be synchronized with selection of the selectable portions such that a single help element 120(h) is displayed at a particular point in time, further discussion of which may be found in relation to FIGS. 3 and 4. In another example, the help elements 120(h) may be formed into groups 122, such as based on topic and so on. In this example, the grouping may be used to provide a variety of functionality, such as to control “focus” given to particular selectable portions in a user interface, manage which help elements are displayed and how those elements are displayed, provide default 124 help elements that correspond to a selected portion when a matching help element is not available, and so on. Thus, a variety of techniques may be employed in the output of help elements, further discussion of which may be found in relation to the following exemplary user interfaces.

Generally, any of the functions described herein Can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., memory 110. The features of the techniques to output help elements described below are platform-independent, meaning that the techniques may be implemented on a variety of commercial computing platforms having a variety of processors.

FIGS. 2 and 3 illustrate exemplary user interfaces 200, 300 in an implementation showing sequential output of help elements in response to sequential selection of selectable portions in the respective user interfaces. The user interfaces 200, 300 are illustrated as being output via a browser and therefore may by output by the communication module 112 as previously described. Further, the user interfaces 200, 300 are illustrated as outputting a web page received via the network 106 to create an ID to logon to network-based services.

The user interfaces 200, 300 include a plurality of selectable portions which may be configured in a variety of ways. For example, a drop-down selectable portion 202 may be used to select from a variety of different choices, such as “country/region” in the illustrated instance. The user interfaces 200, 300 may also include a text-entry selectable portion 204 to receive text input by a user, which in the illustrated instance is utilized to enter a proposed ID. Further, the user interfaces 200, 300 may also include a button 206 which is selectable to initiate functionality, such as to check availability the proposed ID entered in the selectable portion 204. A variety of other examples of selectable portions are also contemplated.

When interacting with the content, the user may select the selectable portions in sequence to input data, such as through the use of a cursor control device, “tabbing”, and so on. In an implementation, the output of help elements is synchronized with the sequential selection such that information relevant to the currently selected portion is output, thereby reducing clutter as opposed to traditional techniques.

A user, for example, may select the portion 202 to input a country/region. Upon selection of the portion, a help element 208 is output. For instance, the help element 208 may be output using non-modal techniques such that the help element 208 does not require an input from the user to be removed from the user interface 200. In other words, the help element 208 may be output yet not interfere with interaction with the selectable portion. A variety of other examples are also contemplated, such as through the use of “modal” elements. The help element 208 includes information relating to the portion that is selected. In an implementation, information contained within the help element 208 may change to address data as it is being entered in the field, such as to acknowledge that a selection was made successfully, unsuccessfully, that data entered is not compatible, and so on. The “changing” of the help element may be performed as interaction is being performed, and thus may be accomplished before a user selects an “enter” key and so on. Again, a variety of other examples are also contemplated.

The user may then select another one of the selectable portions as shown in FIG. 3, e.g., the portion 204 used to input a proposed ID. Accordingly, another help element 302 may be output proximally to the portion 204 that includes information related to the portion, which in this instance is illustrated as “Type the name that you want to use for your Windows Live ID”. In this way, a user may sequentially select portions of the user interface and have help elements relating to those portions output in synchronization.

In an implementation, the user interface, through execution of the help module 118, may also support functionality to allow a user to “turn on” each help element that relates to a selectable portion on the page, such as through selection of a “show all” button 304 as illustrated in FIG. 3. These help elements may be displayed in a variety of different ways.

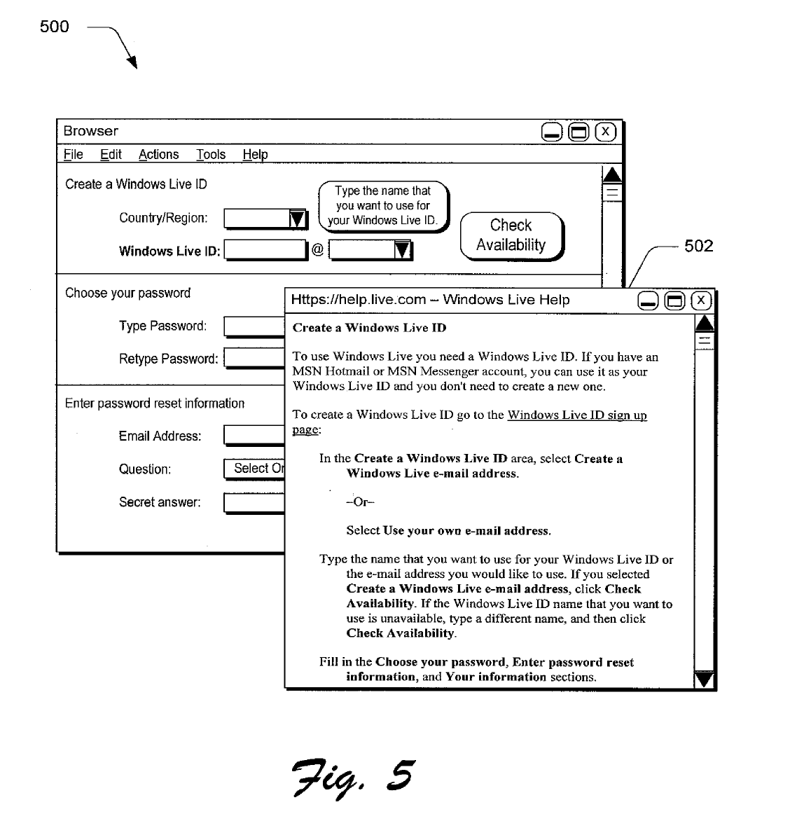

FIG. 4, for instance, is an illustration of a user interface 400 in which help elements that correspond to selectable portions are aggregated for display in the user interface. The help elements 402 in the illustrated instance are collected from the help elements that would be sequentially displayed as described in FIGS. 2 and 3, but in this instance are aggregated for concurrent display together. Additionally, the help elements relate to portions that are currently displayed within the user interface 400. In other words, the help elements correspond to portions that are currently selectable. The help elements may also relate to portions that are not currently displayed but may be displayed through interaction with the current content, such as portions that may be scrolled 404 for display in the user interface 400. Thus, the control 304 may be used to improve accessibility of the help elements. A variety of other techniques may also be employed to aggregate and display the help elements, such as through the use of a “pop-up” window 502 as shown in the exemplary implementation 500 of FIG. 5.

Exemplary Procedures

The following discussion describes output techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interfaces 200-500 of FIGS. 2-5.

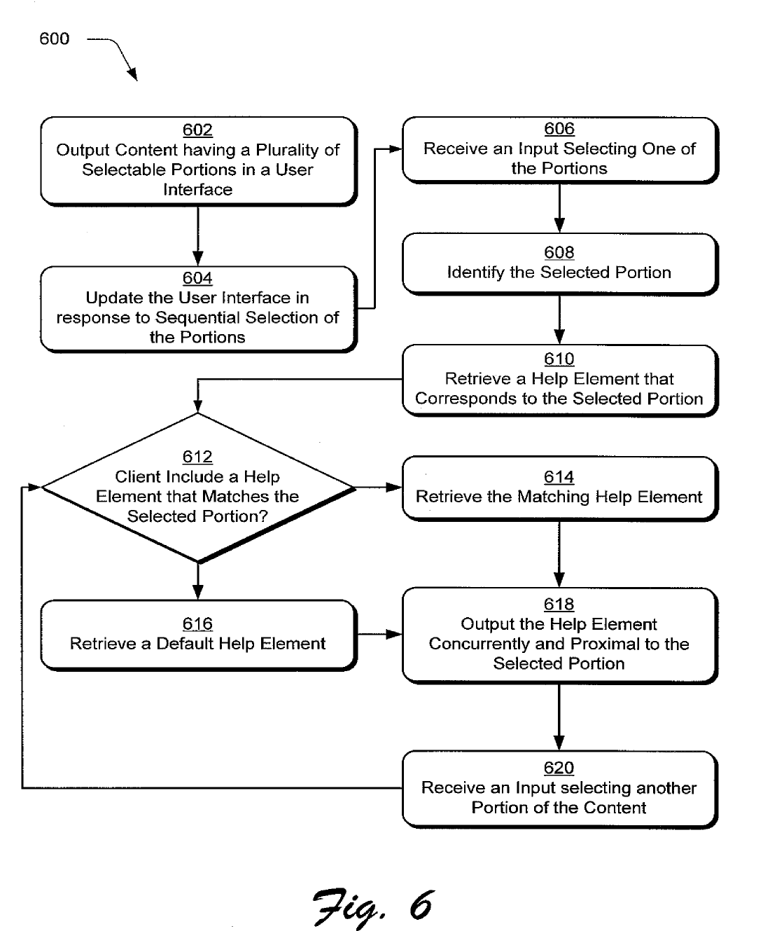

FIG. 6 depicts a procedure 600 in an exemplary implementation in which help elements are retrieved from local storage that correspond to selectable portions included in content obtained over a network. Content is output, in a user interface, having a plurality of selectable portions (block 602). The content, for instance, may be configured as a web page shown in FIG. 2-5 that was received by the client 104 via interaction with a network-based service 114(s), such as to logon to the network-based service 114(s).

The user interface is updated in response to sequential selection of the portions (block 604). The user, for instance, may use a cursor control device and/or keyboard to navigate to different selectable portions 202-206.

Through this interaction, an input may be received selecting one of the portions (block 606). For example, the communication module 112 may receive the input from a user that “tabs” to a particular portion 202 in the user interface 202 to select the portion. The select portion is identified (block 608), such as by reading a tag that corresponds to the portion by the help module 118. A help element is retrieved that corresponds to the select portion (block 610). The help module 118, for example, may “look” at help elements 120(h) included in storage (e.g., memory 110) that is local to the client 104 to locate one or more help elements 120(h) that correspond to the selected portion.

The help module 118, for instance, may determine whether the client includes a help element that matches the selected portion (decision block 612), such as a help element that specifically corresponds to an identified tag. If so (“yes” from decision block 612), the matching help element is retrieved (block 614) and output concurrently and proximally to the selected portion (block 618). Help element 208 of FIG. 2, for instance, may match the portion 202 that therefore be displayed proximal to the portion 202.

When a matching help element is not included on the client (“no” from decision block 612), a default help element is retrieved (block 616) that corresponds to the selected portion. For example, even though a particular help element may not be found that matches the selected portion, e.g., is configured for a particular tag included in hypertext markup language (HTML) content, a default tag may be found that corresponds to a general topic of the selected portion. The help elements, for instance, may be arranged into groups 122 based on topic, such as location-based topics (e.g., country, state, street address), password (e.g., enter password, verify password), and so on. Therefore, when a particular help element cannot be found that matches the selected portion (e.g., there is not a help topic for “Windows Live ID”), a default topic may be found that relates to an ID in general. This default help element may also be output concurrently and proximal to the selected portion (block 618) as previously described. A variety of other techniques are also contemplated to locate default help elements, such as through a keyword search.

This procedure 600 may also be iterative, such that, when an input is received that selects another portion of the content (block 620), another determination is performed as to whether the client includes a help element that matches the selected portion (block 612). Additionally, although this procedure 600 described location of help elements as being stored locally on the client 104, the help elements may be stored in a variety of other ways, such as accessible of the network 106 from a service provider 102 that provided the content via an application programming interface, from a database of help elements that are accessible by other users (and further which may be modifiable by the other users), and so on.

FIG. 7 depicts a procedure 700 in an exemplary implementation in which focus is applied to groups of selectable portions in a user interface, the groups further defining which help elements are output in the user interface. A user interface is output having a plurality of selectable portions arranged into a plurality of groups and a help element (block 702). The user interface 200, for instance, may output a help element 208 as previously described. In addition, the user interface 200 may arrange selectable portions into groups, such as a first group 210, a second group 212 and a third group 214. Focus may be shown in a variety of ways, such as through shadowing, bolding, italicizing, highlighting, and/or a color change of selectable portions to differentiate the group having focus from another group that does not have focus.

Although the groups (e.g., the first, second and third groups 210, 212, 214) are delineated through the use of lines in FIG. 2, the groups may be formed logically based on a variety of considerations, such as by topic and so on. Additionally, the groups may be arranged to form a hierarchy, and therefore a particular group may have sub-groups. For instance, a group may be formed to correspond to “login data” and subgroups may be formed such as for “address”, “name”, and so on. A variety of other instances are also contemplated.

An input is received (block 704), such as through interaction with a cursor-control device (e.g., a touch screen of a wireless phone), a mouse, “tabbing” through use of a keyboard, and so on. A determination is then made as to whether the received input selects another selectable portion of the user interface (decision block 706). If not (“no” from decision block 706), output of the help element is continued (block 708). For example, an input may be receive that “clicks” on a blank area of the user interface and therefore output of the help element 208 is continued to assist the user with the last selected portion.

When the received input selects another selectable portion (“yes” from decision block 706), a determination is made as to whether the selectable portion is included in a group having the focus (decision block 710). The user, for instance, may navigate from the selectable portion 202 to another selectable portion that is included within a same topic group, e.g., “logon” in this instance. Therefore, in this instance the output of the help element may be continued (block 708), such as in an instance in which the subject matter of the help element still pertains to the newly selected portion. In another instance, however, another help element may be output that pertains to the newly selected portion, as described in relation to FIG. 3. A variety of other instances are also contemplated.

When the selectable portion is not included in the group having the focus (“no” from decision block 710), the user interface is output as having focus switched to another group having the selectable portion and having another help element relating to the portion (block 712). As before, focus may be shown in a variety of ways, such as through shadowing, bolding, italicizing, highlighting, and/or a color change of selectable portions to differentiate the group having focus from another group that does not have focus. A variety of other examples are also contemplated. Thus, selectable portions that are within a same group may be differentiated from other groups and help elements output based on the groups. A variety of other examples are also contemplated.

FIG. 8 depicts a procedure 800 in an exemplary implementation in which a control is used to switch between modes to manage output of help elements. A user interface is output having a plurality of portions and a control to place the user interface in first and second modes (block 802). The control may be output in a variety of ways, such as through a “pop-up” menu that is output in response to a “right-click” of a cursor-control device, display of a button, a keyboard combination, and so on.

When in the first mode, the user interface is configured such that when a single one of the portions is selected, a single help element relating to the selected portion is output (block 804). For example, the first mode may correspond to sequential output as described in relation to FIGS. 2 and 3 such that a single help element is output at any one time.

When in the second mode, the user interface is configured such that a plurality of help elements corresponding to a plurality of the portions is displayed in the user interface (block 806). The second mode, for example, may correspond to the output of a plurality of help elements as shown in FIGS. 4 and 5 such that a plurality of help elements is output at any one time, which may or may not correspond to selection of particular portion of the user interface. Thus, the second mode may be used to increase accessibility and usability to users that interact with the user interfaces 400, 500 that do not desire to engage in sequential output of the help elements. A variety of other examples are also contemplated without departing from the spirit and scope thereof.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
outputting content obtained via a network in a user interface having a plurality of selectable portions and a help element; and
updating the user interface in response to sequential selection of the plurality of selectable portions by retrieving corresponding help elements that were stored locally on the client before the content was obtained and outputting the corresponding help elements as synchronized with the sequential selection.

2. A method as described in claim 1, wherein the updating includes:
identifying a particular said portion;
when the client does not include at least one said help element that matches a particular said portion, retrieving a default said help element.

3. A method as described in claim 2, wherein:
the plurality of help elements are arranged into groups; and
the default said help element is included in one of the groups that corresponds to the particular said portion.

4. A method as described in claim 2, wherein the default help element corresponds to a topic of the particular said portion.

5. A method as described in claim 1, wherein the plurality of help elements are arranged into a hierarchy of groups based on topic and sub-topic.

6. A method as described in claim 1, wherein the corresponding help elements are synchronized with the sequential selection such that a single said help element is displayed at a particular point in time that corresponds to selection of a corresponding single said portion.

7. A method as described in claim 1, wherein:
the portions are arranged into groups;
when an input is received selecting another said portion in another said group, outputting the user interface as having focus switched to the other said group and having another help element relating to the other said portion

8. A method as described in claim 1, wherein the user interface includes a control to switch between:
a first mode such that when a single said portion is selected, a single said help element corresponding to the selected portion is output; and
a second mode such that a plurality of said help elements corresponding to a plurality of said portions is displayed in the user interface.

9. A method comprising:
outputting a user interface having a plurality of selectable portions arranged into a plurality of groups and a help element, wherein:
the help element relates to a particular said portion in a particular said group; and
the particular said group is output as having focus in the user interface with respect to another said group; and
when an input is received selecting another said portion in another said group, outputting the user interface as having focus switched to the other said group and having another help element relating to the other said portion.

10. A method as described in claim 9, wherein each said portion in the particular said group, when having focus, is selectable such that the output of the help element relating to the particular said portion is continued.

11. A method as described in claim 9, wherein:
the plurality of selectable portions are configured from data received from a service provide via a network; and
the help element and the other help element are retrievable locally on a client that performs the outputting.

12. A method as described in claim 9, wherein at least one of the selectable portions is configured to receive text input by a user.

13. A method as described in claim 9, wherein the help element is output proximally to the particular said group and displayed over at least one other said selectable portion that is not included in the particular said group.

14. A method as described in claim 13, wherein when the input is received selecting the other said portion in the other said group, the other help element relating to the other said help element is displayed proximally to the other said group.

15. One or more computer-readable media comprising executable instruction that, when executed, direct a client to output a user interface having a plurality of portions that are selectable and a control to place the user interface in:
a first mode such that when a single said portion is selected, a single help element relating to the selected portion is output; and
a second mode such that a plurality of help elements corresponding to a plurality of said portions is displayed in the user interface.

16. One or more computer-readable media as described in claim 15, wherein when the user interface is placed in the first mode, output of the user interface is configured such that another help element is not displayed that relates to another said portion displayed concurrently in the user interface with the selected single said portion.

17. One or more computer-readable media as described in claim 15, wherein the control is selectable by a user through interaction with the user interface.

18. One or more computer-readable media as described in claim 15, wherein the computer-executable instructions configure the client to retrieve one or more said help elements from local storage and wherein the plurality of portions are included in content received by the client via a network connection.

19. One or more computer-readable media as described in claim 15, wherein the computer-executable instruction configure the client, when in the second mode, to retrieve the plurality of help elements corresponding to the plurality of portions and display the plurality of help elements as aggregated in the user interface.

20. One or more computer-readable media as described in claim 19, wherein the aggregated help elements are concurrently displayed within a window along with at one or more said portions.
